(19) United States
(12) Patent Application Publication
(10) Pub. No.: US 2008/0012392 A1
(43) Pub. Date: Jan. 17, 2008

(54) Vehicle Glazing With Darkened Areas

(75) Inventors: Tobias Gerl, Muenchen (DE); Robert Koch, Langerringen (DE); Bernhard Harnischfeger, Dachau (DE)

Correspondence Address: ROBERTS, MLOTKOWSKI & HOBBES, P. O. BOX 10064, MCLEAN, VA, 22102-8064, US

(73) Assignee: WEBASTO AG, Stockdorf (DE)

(21) Appl. No.: 11/576,739

(22) PCT Filed: Oct. 5, 2005
(86) PCT No.: PCT/DE05/01788

§ 371 Date: Sep. 19, 2007

(30) Foreign Application Priority Data
Oct. 5, 2004 (DE) 10 2004 048 469.4

(51) Int. Cl. B62D 25/06

(52) U.S. Cl. 296/215

(57) ABSTRACT

A vehicle glazing, especially for use as a glass roof of a motor vehicle, the glazing having a glass body (10) which has been provided with a dark tinting in areas that are spaced apart from its edge area. The dark tinting is formed from an opaque substance which cross-links with the glass body (10) and which is applied to the glass body (10) to limit or prevent viewing through the transparent regions (14).

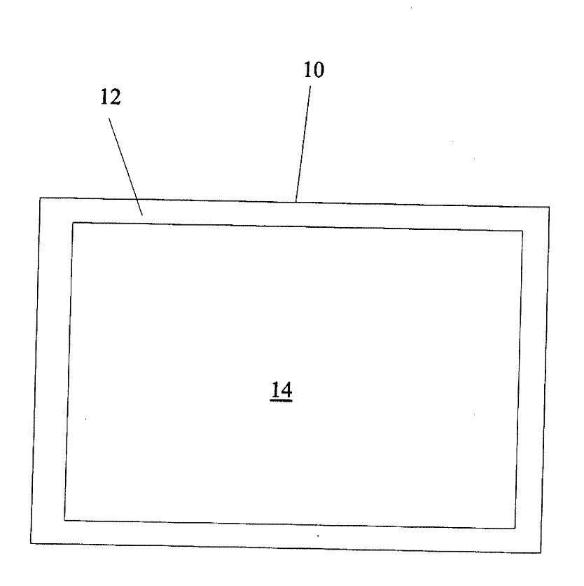

### BACKGROUND OF THE INVENTION

1. Field of the Invention

The invention relates to motor vehicle glazing, especially the glass roof of a motor vehicle comprising a glass body which is provided with dark tinting to close off transparent regions spaced apart from its edge area.

2. Description of Related Art

The initially mentioned type of motor vehicle glazing is known from practice and is used, for example, as the glass roof of a passenger car made as a coupe or limousine. For decorative reasons, in this connection, it is often desirable to make a large part of the body of the pane opaque, especially in central regions. In this way, for an onlooker located outside the vehicle, for example, body components or also other functional modules, such as a sliding roof frame or the like, can be masked. For these purposes, the glass body is provided with dark tinting to close off transparent regions.

For dark tinting, the glass body, which is generally formed from tempered glass (ESG), has been imprinted in the past with an overglaze color or glass frit, for example, in the pertinent regions. The imprinting which can be done over the entire surface or also according to a spot pattern is performed before a thermal hardening process to which the glass body is subjected before its use as a glazing of a motor vehicle. The glass frit fuses in the hardening process which takes place for example at 480° C. with the glass body which constitutes a carrier material.

However, the use of a glass frit has the disadvantage that the overglaze color on the surface of the glass body reduces its resistivity in imprinted regions. Since the glass frit may no longer contain lead due to legal regulations, this effect is especially pronounced. When the glass body is imprinted over its entire surface or over a large area with a pattern, for example, a grid of points, the glass body is weakened such that, for example, in case of a stone impacting on it, there is increased danger of breakage; this applies especially to glass bodies which are relatively thin. As a result, the requirements for the prescribed falling-ball test can no longer be met.

Alternatively, producing the dark tinting by two-dimensional underfoaming of the glass body with a polyurethane foam, by applying a film or also by applying a dark component which is formed, for example, of blackened sheet metal or blackened plastic, is known. For two-dimensional underfoaming of the glass body with polyurethane foam, pretensioning is applied to the glass body by shrinkage which takes place when the foam cools and which can, likewise, lead to increased danger of breakage and also to influencing of convexity. When the dark tinting is formed from a film, there is the disadvantage that the film can partially come loose over time. Processes according to which the film can be applied such that later loosening is prevented are very complex and expensive. The application of an additional, nonreflective dark component is also associated with considerable effort and thus also with high costs.

### SUMMARY OF THE INVENTION

A primary object of the present invention is to devise vehicle glazing which is at least partially opaque in central regions so that no weakening of the glass body results from forming the opaque regions.

This object is achieved in accordance with the invention by a vehicle glazing in which the dark tinting is formed from an opaque substance which cross-links with the glass body to which it is applied.

The heart of the invention is, moreover, that the opaque substance which cross-links with the glass body is used for darkening the glass body such that the vehicle glazing is made opaque in central regions and in those regions spaced apart from the edge of the glass body. The substance which cross-links with the glass body is applied for this purpose simply in liquid form to the pertinent transparent, optionally large-area regions of the glass body. The substance which cross-links with the glass body is therefore used as an effectively adhering color which is applied to the generally hardened glass body which is thus essentially ready to be installed. The substance used to darken the glass body slightly etches the surface of the glass body, molecular cross-linking of the substance with the glass body taking place. Therefore, a chemical bond forms between the opaque substance and the glass body. The cross-linking of the substance with the glass body can be accelerated by applying heat. In particular, cross-linking forms a permanently durable coating of the glass body.

Vehicle glazing in accordance with the invention in which the glass body is produced, for example, from tempered glass (ESG) can be made opaque over a large surface, and legal safety regulations must be observed. The fracture behavior of the glass body is not changed by the application of the opaque substance.

In one preferred embodiment of the vehicle glazing in accordance with the invention, the opaque substance which cross-links with the glass body is a glass primer, especial a black glass primer or black primer. A glass primer constitutes a substance or adhesive which was used in the past as a wash primer on glass panes and which is used to improve adhesion between the cement systems and the surface of the glass body, and an opaque glass primer can protect the cement which is being used against ageing by the action of light.

Application of the opaque substance which cross-links with the glass body is economical and possible with simple aids. Generally, the substance is manually applied in liquid form by means of a brush, a wool wiper, or felt. Alternatively, automated application can also take placed by means of a robot.

An opaque substance which is made as a glass primer and which cross-links with the glass body can comprise, for example, reactive polyisocyanates as the binder. The drying time of this substance is, for example, between 5 and 10 minutes.

In addition to use as dark tinting, in corresponding regions, the glass primer can also be used as an adhesive system for cementing the glass body to the vehicle body or when foaming around the edge regions of the glass body with polyurethane or the like.

The glass pane can provided with a glass frit for technical reasons, especially in the region of possible cementing. In the regions of the glass body which have not been imprinted with the glass frit, an opaque substance which constitutes a permanently adhesive liquid coating can be applied over the entire area or also only in regions.

In vehicle glazing performed in accordance with the invention, the glass body can also have a low thickness, i.e., for example, roughly 2 mm to 5 mm, and nevertheless, can be sufficiently shatterproof.

Other advantages and advantageous configurations of the vehicle glazing in accordance with the invention will be apparent from the following detailed description in conjunction with the accompanying drawings in which one embodiment of vehicle glazing in accordance with the invention is shown schematically in simplified form.

### BRIEF DESCRIPTION OF THE DRAWINGS

The sole FIGURE of the drawings shows a vehicle glazing used on a glass roof for a vehicle.

### DETAILED DESCRIPTION OF THE INVENTION

The drawing shows a vehicle glazing which comprises a glass body 10 and which constitutes part of a glass roof of a passenger car made as a limousine. The illustrated glass roof part is located, for example, above the area of the rear seats of the vehicle interior.

The glass body 10 has a thickness of roughly 4 mm and has an edge region 12 which is used, for example, to cement the vehicle glazing 10 to the vehicle body. The edge region 12 can be provided with a glass frit formed from an over-glaze color.

The edge region 12 can be additionally or alternatively provided with a peripheral foam framing of polyurethane for cementing.

In a large-area central region, the glass body 10 is provided with a black glass primer on its surface so that the vehicle glazing 10 is also made opaque in the region 14.

Alternatively, can also be provided with a black glass primer only in areas of the central region 14 of the glass body 10, this primer having been applied in liquid form so that the transparency of the glass body is reduced.

1-5. (canceled)

6. Vehicle glazing for a glass roof of a motor vehicle, comprising a glass body to which a dark tinting has been applied to close off transparent regions that are spaced from an edge area of the glass body, wherein the dark tinting is formed of an opaque substance which has been cross-linked with the glass body.

7. Vehicle glazing as claimed in claim 6, wherein the cross-linked opaque substance is a glass primer

8. Vehicle glazing as claimed in claim 6, wherein the glass primer is a black glass primer.

9. Vehicle glazing as claimed in claim 6, wherein the glass body has been coated with the opaque substance over an essentially large area or the entire surface.

10. Vehicle glazing as claimed in claim 6, wherein the glass body has a glass frit at least in its edge regions.

11. Vehicle glazing as claimed in claim 6, wherein the glass body has a thickness between about 2 mm and 5 mm.

12. Vehicle glazing as claimed in claim 7, wherein the cross-linked opaque substance is a glass primer that has been applied as a coating over at least a large central area of the glass body; wherein the glass body has a glass frit at least in its edge regions, and wherein the glass body has a thickness between about 2 mm and 5 mm.
